(19) United States
(12) Patent Application Publication
(10) Pub. No.: US 2025/0237500 A1
(43) Pub. Date: Jul. 24, 2025

(54) X-RAY APODIZATION FILTER

(71) Applicant: Thermo EGS Gauging LLC, Wilmington, MA (US)

(72) Inventor: Carter Watson, Wilmington, MA (US)

(21) Appl. No.: 19/029,690

(22) Filed: Jan. 17, 2025

Related U.S. Application Data
(60) Provisional application No. 63/622,827, filed on Jan. 19, 2024.

(51) Int. Cl. G01B 15/02

(52) U.S. Cl. CPC G01B 15/025

(57) ABSTRACT

An x-ray system for measuring a thickness of a material includes a source configured to emit a fan beam of x-ray energy along a beam path. A filter is disposed in the beam path. The filter includes a first thickness positioned in a substantially peripheral region of the fan beam and a second thickness positioned in a substantially central region of the fan beam. The first thickness is different than the second thickness. A detector array includes a plurality of detectors. The detector array is configured to detect the x-ray energy transmitted through the filter. The x-ray energy strikes each detector at an angle associated with the region of the fan beam.

### CROSS-REFERENCE TO RELATED APPLICATIONS

The present application claims priority to U.S. Provisional Patent Application No. 63/622,827, filed on Jan. 19, 2024 and entitled “X-Ray Apodization Filter,” the contents of which is hereby incorporated by reference in its entirety.

### TECHNICAL FIELD

Aspects as disclosed herein relate to a filter that shapes an x-ray energy profile across a measurement area in a fan beam application.

### BACKGROUND

X-rays have been used in industrial processes to, among other things, measure the thickness of sheet material. Because conventional x-ray thickness measurement devices have a narrow field of view, the thickness measurements are generally estimates of thickness based on measuring only a small portion of the sheet material where large portions of the sheet material are often left unmeasured. In some applications, any variances in sheet material may adversely affect end products using the sheet materials. Some x-ray thickness measurement devices sweep across the sheet material while the sheet material is conveyed. In such applications, the measured portion is still only the portion of the sheet material actually measured by the x-ray thickness measurement device. Furthermore, merely replicating the number of x-ray thickness measurement devices used is prohibitively expensive.

In some implementations, x-ray sources utilized in thickness measurement devices produce what is referred to as a fan beam that typically provides “full width” exposure across a sheet of material. When using x-ray measurement of the thickness of materials at various points across a fan-beam, the angle that the beam passes through the material can vary significantly from the normal incidence (90 degrees). This means length of the beam-path through the material can vary typically with a simple trigonometric function of the beam-angle. This presents a variably hardened beam to the detector(s) in the beam-path, which can lead to significant variations in measurement performance across the array.

Therefore, a need exists to reduce the variation in measurement performance in fan beam applications.

### SUMMARY

In some aspects of the present disclosure, the techniques described herein relate to an x-ray system for measuring a thickness of a material. The x-ray system includes a source configured to emit a fan beam of x-ray energy along a beam path. A filter is disposed in the beam path. The filter includes a first thickness positioned in a substantially peripheral region of the fan beam and a second thickness positioned in a substantially central region of the fan beam. The first thickness is different than the second thickness. A detector array includes a plurality of detectors. The detector array is configured to detect the x-ray energy transmitted through the filter. The x-ray energy strikes each detector at an angle associated with the region of the fan beam.

In further aspects of the present disclosure, the techniques described herein relate to an x-ray system for measuring a thickness of a material. The x-ray system includes a source configured to emit a fan beam of x-ray energy along a beam path. A filter is disposed in the beam path. A detector array includes a plurality of detectors. The detector array is configured to detect the x-ray energy transmitted through the filter. The x-ray energy strikes each detector at an angle associated with the region of the fan beam. The filter shapes an energy profile of the x-ray energy.

In yet further aspects of the present disclosure, the techniques described herein relate to a method for measuring a thickness of a material. The method includes emitting a fan beam of x-ray energy along a beam path. The beam path includes a substantially peripheral region and a substantially central region. The substantially peripheral region of the beam path extends through a first thickness of a filter. The substantially central region of the beam path extends through a second thickness of the filter. The first thickness is different than the second thickness. The x-ray energy is received in a detector array.

Other aspects of the disclosure will become apparent by consideration of the detailed description and accompanying drawings.

### BRIEF DESCRIPTION OF THE DRAWINGS

The present disclosure is illustrated by way of example, and is not limited, in the accompanying Figures in which like reference numerals indicate similar elements.

FIG. 1 is a schematic view of a system configured to measure the thickness of a material, according to some aspects of the present disclosure.

FIG. 2 is a side view of an x-ray source of the system of FIG. 1, that produces a fan beam of x-ray energy according to some aspects of the present disclosure.

FIG. 3 is a graph showing an exemplary ratio of path length through a material, according to some aspects of the present disclosure.

FIG. 4 is a side view of an enclosure with the x-ray source of FIG. 2 and a filter, according to some aspects of the present disclosure.

FIG. 5 is a cross-sectional view of the filter of FIG. 4, according to some aspects of the present disclosure.

FIGS. 6A-6D are cross-sectional views of various exemplary implementations of filters, according to some aspects of the present disclosure.

FIG. 7 is a graph showing x-ray signals, according to some aspects of the present disclosure.

FIG. 8 is a flowchart illustrating a method for measuring a thickness of a material, according to some aspects of the present disclosure.

### DETAILED DESCRIPTION

Terms that designate a particular spatial orientation or direction, such as “up,” “down,” “upward,” “downward,” “top,” “bottom,” “lower,” “upstream”, and “downstream” are used for ease of understanding and particularly for indicating positions of certain elements relative to other elements. These terms may also refer to preferred orientations of elements, when positioned in a scanning station. However, these terms do not limit the stations or components, described herein, to particular spatial orientations. The interchangeability, for example, of an x-ray source and shroud positioned above a material would be understood by those skilled in the art, as encompassing an x-ray source and shroud positioned below a material.

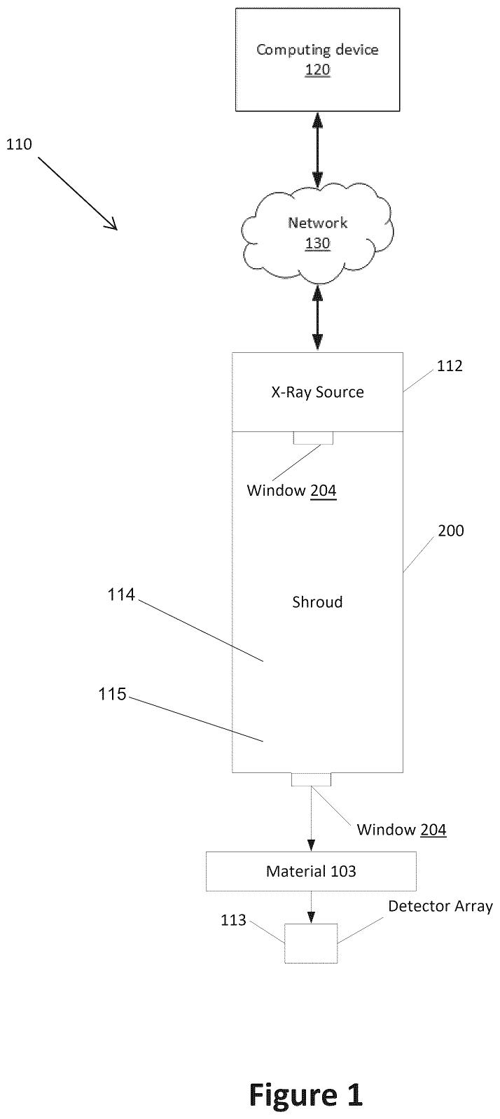

Embodiments relate to a filter usable with a fan beam x-ray measurement system for shaping the energy of a beam emitted by an x-ray source. The filter is configured to compensate for differences in path lengths of an emitted x-ray beam through a material. The following brief introduction provides an exemplary environment in which the filter may be used. As shown in FIG. 1, an x-ray system 110 measures a thickness of a material 103. The material 103 may include any material. For example, the material 103 may be composed of aluminum, copper, or other material depending on a desired application.

The x-ray system 110 includes an x-ray source 112 and an x-ray detector array 113. The x-ray source 112 is configured to emit x-ray energy 114 along a beam path into the material 103. The x-ray detector array 113 is paired with the x-ray source 112 such that the x-ray detector array 113 comprises a field of view that typically spans the full width of material 103 and produces signals used to detect a thickness of material 103 based on an attenuation of x-ray energy 115 or 115′ after the x-ray energy 114 or 114′ passes through the material 103. Specifically, the x-ray detector array 113 is composed of an array of diodes, or detectors, that detect the x-ray energy 115 or 115′. More specifically, the x-ray energy 115 or 115′ strikes each of the diodes at an angle due to the relative positioning of x-ray source 112 and each diode. In other embodiments, the x-ray detector array 113 may be composed of a single diode that detects the x-ray energy 115. The detector array 113 produces signals in response to the received x-ray energy that computing device 120 employs to measure the thickness of the material 103 at various points along the detector array 113.

FIG. 1 also illustrates an implementation of x-ray system 110 communicatively connected to, computing device 120 via network 130. It will be appreciated that, in some implementations, at least a portion of the computing device 120 may be located separate from x-ray system 110 providing the opportunity for increased computing power at a central location or across multiple locations. One skilled in the art can envision various interconnections, both physical and wireless, between the components of the system. It will further be appreciated that, in some implementations, x-ray system 110 and computing device 120 may be communicatively connected physically without network 130.

It should be understood that, in some implementations, the components of x-ray system 110 may be included in a common housing or platform forming an integrated analytical instrument. However, in other implementations, one or more components of x-ray system 110 may be contained in separate housings or devices and may be coupled (e.g., communicatively, electrically, mechanically, or the like) as needed to carry out the methods described herein. Also, in some implementations the operations described herein as being performed by the components of x-ray system 110 may be combined and distributed in various ways. Further, x-ray system 110 may also include additional components such as power components, and one or more user interfaces (such as display and/or user input devices such as a keyboard, a mouse, a touch screen). X-ray system 110 may also include one or more executable applications configured to carry out various operations of x-ray system 110 that may include, but are not limited to, calibrations operations, measurement operations, etc.

In some aspects, the x-ray system 110 may include an enclosure, such as a shroud 200, that creates an internal environment for the x-ray energy 114. In some embodiments, the shroud 200 surrounds the x-ray source 112 however in other embodiments x-ray source 112 may be external to shroud 200 (e.g. shroud 200 may include one or more windows 204 made of beryllium or other material that transmits x-ray energy without substantial loss). For example, in some embodiments, the shroud 200 may be directly coupled to the x-ray source 112. In other embodiments, the shroud 200 may be spaced from the x-ray source 112. Some embodiments may additionally include a second enclosure or a second shroud used to direct the x-ray energy 114 from the x-ray source 116 toward the material 103. In further embodiments, the x-ray system 10 may not include the shroud 200. Ambient air in the enclosure or shroud 200 can be considered negligible in its effects on the x-ray energy 114 where the enclosure or shroud 200 solely provides an environment for the x-ray energy 114 without affecting the x-ray energy 114. Alternatively, the internal environment within the enclosure of shroud 200 may comprise a vacuum or may be filled with an inert gas such as argon or other inert gas known in the related art that has negligible effects on the x-ray energy.

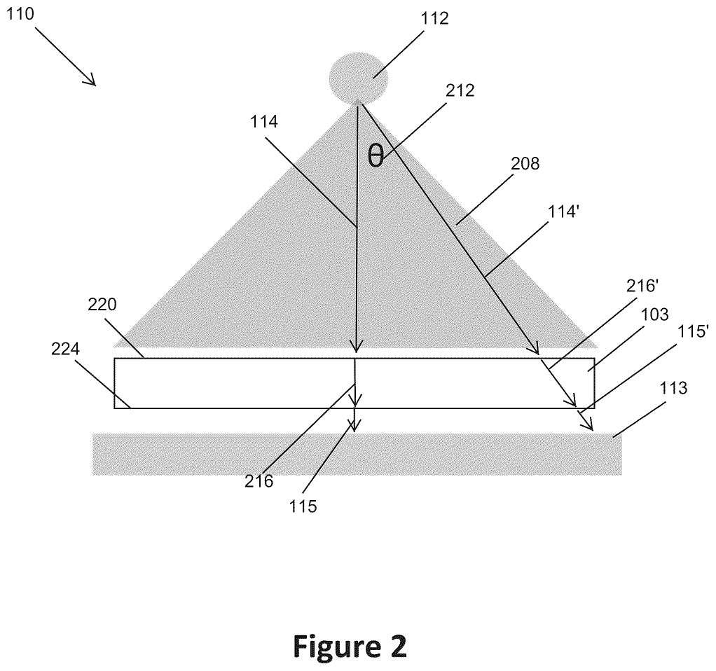

As shown in FIG. 2, the x-ray source 112 emits a fan-beam, such as beam 208, which defines a beam path along which the x-ray energy 114 travels. More specifically, the x-ray source 112 produces beam 208 across a span of degrees appropriate for a desired application, such as for example a 90-degree span of beam 208 comprising photons of energy directed to material 103. In other words, some embodiments of beam 208 extend from a −45-degree beam angle θ 212 to a +45-degree beam angle θ 212. In other embodiments, the beam 208 may extend less than −45 degrees and/or more than +45 degrees. In the presently described example, beam 208 may extend from a −30 degree beam angle 212 to a +30 degree beam angle or more broadly from a −0 degree beam angle 212 to a +0 degree beam angle. Beam 208 comprises a substantially central region, or a center, where a beam angle θ 212 is 0 degrees, and substantially peripheral regions, or edges, where a beam angle θ 212 is, for example, at −45 degrees and +45 degrees, respectively.

Because of the beam angle θ 212, photons at the center of the beam 208 impact the material 103 at about 0 degrees progressing across fan beam 208 where photons towards the edges of the beam 208 impact the material 103 at increasing angle values (e.g. +/−) that may include an angle of about +/−45 degrees. Therefore, the photons at the center of the beam 208 travel a first distance through the material 103 and photons towards the edges of the beam 208 travel increasing distances through the material 103, for example a second distance at the peripheral edge of fan beam 208, the first distance being less than the second distance due to the angle of incidence at the location of material 103. In other words, a path along which the photons travel within the material 103 between a first surface 220 of the material 103 and a second surface 224 of the material 103, or a path length 216 through the material 103, changes according to the beam angle 212. Therefore, the path length 216 through the material 103 at the center of the fan beam 208 is shorter than the path length 216′ through the material 103 at the peripheral edges of the fan beam 208. For example, the path length 216 through the material 103 extends from the first surface 220 of the material 103 to the second surface 224 of the material 103. Therefore, the path length 216 through the material 103 defines the path the photons travel within the material 103 at the center position of fan beam 208.

When the beam 208 passes through the material 103, the x-ray detector array 113 produces a plurality of signals that computing device 120 uses to measure the energy level of beam 208 that has passed through various points along the width of material 103. More specifically, the signals produced by x-ray detector array 113 are employed to calculate the thickness and/or weight of the material 103 based on the attenuation of x-ray energy 115 (emitted by the x-ray source 112) as passing through the material 103. In some embodiments, computing device 120 may use the calculated thickness and/or weight values to calibrate some or all of the elements of detector array 113. For example, the diodes of the x-ray detector array 113 receive the attenuated x-rays 115 and the detector array 113 produces the signals used by computing device 120 to determine the thickness and/or weight of the material 103 based on the path lengths (e.g. 216 and 216′) through the material 103. Specifically, each of the diodes corresponds to an area of average path length through the material 103. In the presently described example, attenuated x-rays 115 at the center correspond to a diode at a center of the x-ray detector array 113 while attenuated x-rays 115′ at the edge correspond to a diode at an edge of the x-ray detector array 113. Since the path length 216 through the material 103 is shortest at the center of the beam 208 and gradually increases as the beam angle θ 212 increases, the detector 113 produces signals that computing device 120 uses to measure different material thicknesses at each of the path lengths through the material 103. In other words, the path lengths through the material 103 increases from the center to the edge of the beam 208.

To calculate the path lengths (e.g. 216 and 216′) through the material 103, the path length through the material 103 may be calculated using simple trigonometric arguments by computing device 120, such as for example by multiplying the path length by 1/Cos (beam angle θ 212), with the beam angle θ 212 being measured between the center and the path length through the material 103.

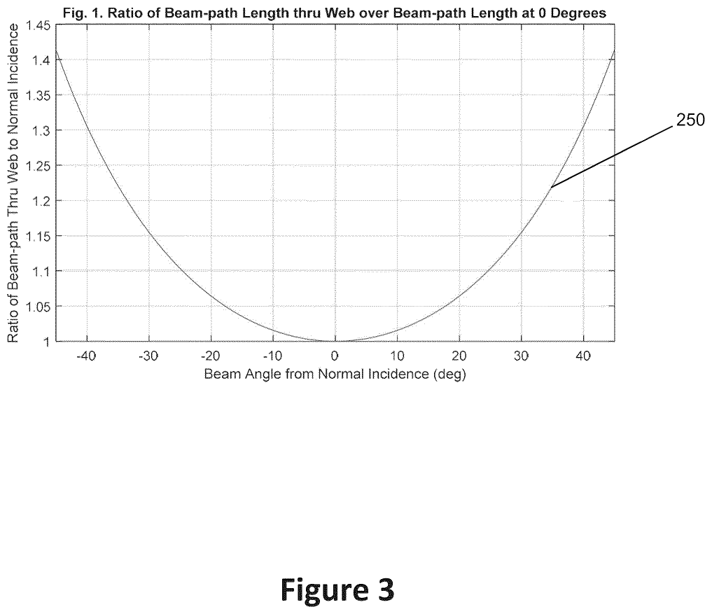

For example, FIG. 3 shows the described cosine function 250 for beam angles between −45 degrees and +45 degrees. Therefore, the x-ray energy 114′ at the edge of the beam 208 has a path length 216′ through the material 103 that is approximately 41% greater than a path length 216 through the material 103 that the x-ray energy 114 at the center has. In other words, the first distance of the path length 216 through the material 103 at the center may be between 65% and 75% of the second distance of the path length 216′ through the material 103 at the edge of the material 103 being measured for thickness. This variation in distance travelled through the material 103 decays the signal intensity measured by the detector array 113. Further, the variation in distance travelled through the material 103 also impacts the energy spectra, resulting in beam-hardening. This can cause performance issues during calibration and measurement of the material 103. Further, a material weight and/or density of the material 103 may additionally impact the energy spectra.

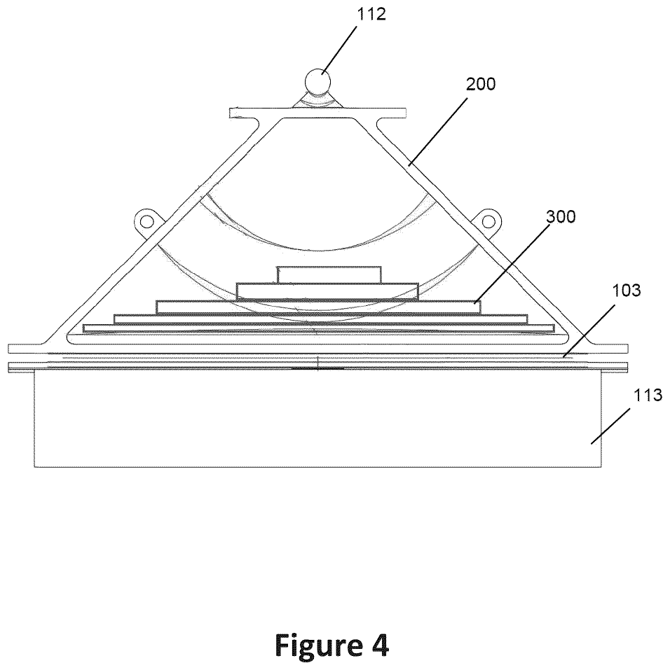

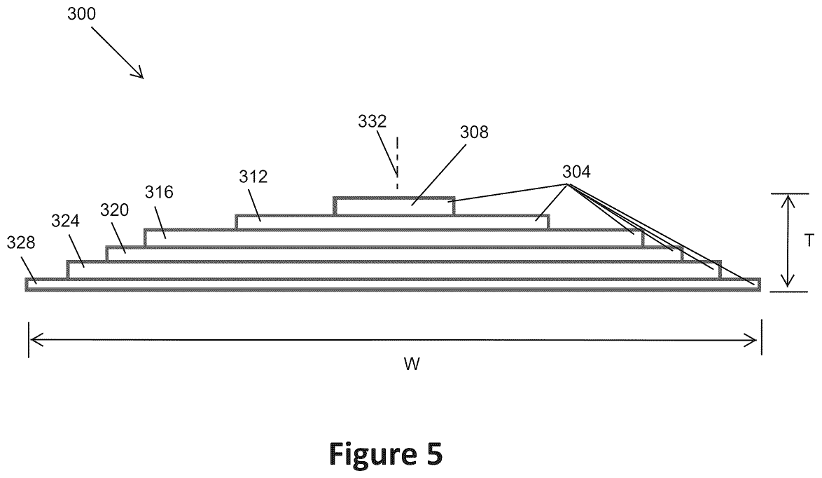

With reference to FIGS. 4 and 5, the x-ray system 10 may further include a filter 300 configured to shape the beam 208. The filter 300 may be disposed at any location within the beam 208 (see FIG. 2) between the x-ray source 112 and the detector array 113. For example, filter 300 can be positioned at a location proximal to window 204 proximal to x-ray source 112, at a location proximal to window 204 defining the internal environment boundary of shroud 200 nearest to material 103, or at any location in between. With reference to FIG. 5, the filter 300 defines a cross-sectional shape having stepped lateral edges that lead to a top or first layer 308, similar to a pyramid. Each of the stepped lateral edges and the top layer 308 define a layer 304. In some embodiments, the layers 304 may be integrally connected. In other embodiments, the layers 304 may be distinct. The first layer 308 is positioned about a center 332 of the filter 300, with each of the layers 304 also being substantially centered about the first layer 308. For example, the filter 300 increases in width W from the first layer 308 to a sixth layer 328. More specifically, the first layer 308 includes a first width, a second layer 312 defines a second width, a third layer 316 defines a third width, a fourth layer 320 defines a fourth width, a fifth layer 324 defines a fifth width, and the sixth layer 328 defines a sixth width. The first width is less than the second width, which is less than the third width, which is less than the fourth width, which is less than the fifth width, which is less than the sixth width.

The filter 300 can increase in overall thickness T from the sixth layer 328 to the first layer 308. More specifically, a thickness at the sixth layer 328 is less than a thickness at the fifth layer 324, which also includes the thickness of the sixth layer 328 below the fifth layer 324. The overall thickness of the filter 300 is greatest at the first layer 308, since the first layer 308 includes thicknesses of all the layers 304. In other words, the thickness of the filter 300 is greatest at the center 332. In the depicted embodiment, the filter 300 includes six of the layers 304. In other embodiments, the filter 300 may include more than six of the layers 304. In other embodiments, the filter 300 may include less than six of the layers 304. Each of the layers 304 can have the same height as the other layers 304. In other embodiments, each of the layers 304 may have different heights. In yet another embodiment, some of the layers 304 may have individual heights that are the same and some of the layers 304 may have heights that are different.

For example, the x-ray source 112 emits the beam 208. As the beam 208 travels through an enclosure or shroud 200, a portion of the x-ray energy 114 that will have a first shortest path length 216 through the material 103 will have passed through the layers 308-328 having the longest first path length through filter 300. In the presently described example, a portion of the x-ray energy 114 that will have a second shortest path length through the material 103 will have passed through layers 312-328 having a second path length through filter 300 that is shorter than the first path length. In the presently described example, this continues such that x-ray energy 114′ at a peripheral region of beam 208 will have the longest path length through the material 103 and will have passed through only the layer 328 having the shortest path length through filter 300.

Returning the FIG. 2, once the x-ray energy of beam 208 across beam angle θ 212 (e.g. from x-ray energy 114 to 114′) exits the filter 300, it travels through the material 103 and exits as attenuated x-rays across beam angle θ 212 (e.g. attenuated x-rays 115 to 115′) that then travel to detector array 113. Filter 300 shapes the profile of x-ray energy across beam angle θ 212 compensate for variation due to the differences of angle at different points of fan beam 208. Specifically, filter 300 shapes an energy profile, a signal intensity profile, and a material thickness profile. In some embodiments, one or more of the energy profile, the signal intensity profile, and/or the material thickness profile are flattened or close to being flattened. In some embodiments, one or more of the energy profile, the signal intensity profile, and/or the material thickness profile are curved or other desired shape.

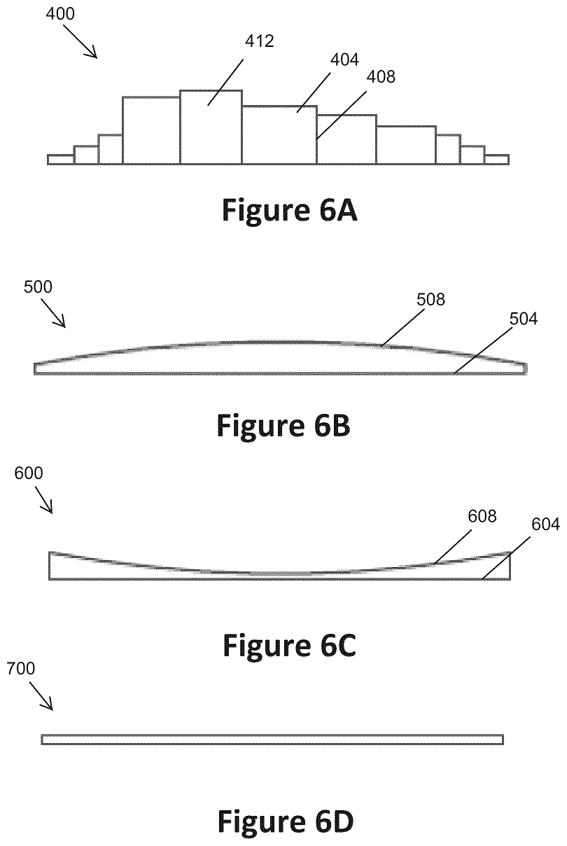

With reference to FIG. 6A-6D, in other embodiments, the filter 300 may include a different cross-sectional shape. For example, the filter 300 may define a cross-sectional shape that is concave, convex, asymmetric, stepped, layered, aspheric, or the like. More particularly, as shown in FIG. 6A, a filter 400 may define a cross-sectional shape having distinct pillars 404 coupled to each other alongside walls 408. The pillars 404 vary in width and height. A top pillar 412 having a tallest height may be positioned off center from a center of the filter 400 as illustrated in FIG. 6A but will also be appreciated that in some embodiments may be positioned at the center of filter 400. In other words, as illustrated in FIG. 6A the top pillar 412 is asymmetrically positioned. The filter 400 may be usable when the center of the x-ray source 112 is not centered with the filter 400.

As an additional example, as shown in FIG. 6B, a filter 500 may define a cross-sectional shape having a flat bottom surface 504 and a convex upper surface 508. This filter 500 may be usable when the length of each path length (e.g. 216, 216′) through the material 103 changes gradually. As an additional example, as shown in FIG. 6C, a filter 600 may define a cross-sectional shape having a flat bottom surface 604 and a concave upper surface 608. The filter 600 may be usable when each path length (e.g. 216, 216′) through the material 103 changes gradually, with the shortest path length through the material 103 being at the edges and the longest path length (e.g. 216, 216′) through the material 103 being at the center. In yet a further example, the embodiments of FIGS. 6A and 6B may be combined where the flat surfaces may be placed against each other to form a single filter embodiment that performs in a manner similar to an achromatic lens structure in optical systems (e.g. may also be constructed as a single piece).

In yet another example, as shown in FIG. 6D, a filter 700 may define a cross-sectional shape that is rectangular. In such embodiments, a thickness of the filter 700 is constant throughout. In other embodiments, the filter 300 may define a different cross-sectional shape. Further, the filter 300 may define a different material weight and/or density.

In use, the x-ray source 112 emits the beam 208. As the x-ray energy 114 travels through an enclosure or shroud 200, a portion of the x-ray energy 114 that will have the shortest distance through the material 103 interacts first with a portion of the filter 300 having a greatest thickness. Portions of the x-ray energy 114 interact with the filter 300 based on their path length (e.g. 216, 216′) through the material 103. Therefore, the x-ray energy 114 interacts with the filter 300 such that the x-ray energy 114 has been shaped after exiting the filter 300. For example shaping the x-ray energy 114 may include flattening an energy profile at detector array 113 such that the energy profile is more uniform. Specifically, the filter 300 shapes an energy profile, a signal intensity profile, and a material thickness profile such that the energy profile, the signal intensity profile, and the material thickness profile are flattened at detector array 113. In embodiments of the filter 300 that have differing material weights and/or densities, the filter 300 additionally shapes the energy profile based on the material weight/or density of the material 103.

In some embodiments, the filter 300 may include a material composition that is the same, or substantially the same, as the material 103. For example, when the material 103 is composed of Titanium, the filter 300 is also composed of Titanium. In these embodiments, the filter 300 is specifically designed for the material 103 being measured. Therefore, the path lengths 216, 216′ are specifically shaped based on the material 103 being measured. In other embodiments, the filter 300 may be composed of a battery material such as ternary cathode materials. In other embodiments, the filter 300 may be composed of copper, aluminum, or the like. In yet further embodiments, the filter 300 may be composed of a synthetic material, such as rubber or plastic. In some embodiments, the filter 300 may be manufactured such that some of the layers 308 are composed of a first material and some of the layers 308 are composed of a second material, with the first material being different than the second material. In other embodiments, the filter 300 may include more than two distinct materials.

To manufacture the filter 300, the filter 300 may be shaped through a heating process. More specifically, a material, such as Titanium, copper, aluminum, plastic, or the like, may be formed through heating the material and pressing the material in a mold. Surfaces of the material are then ground into a final form using an abrasive surface (e.g., emery, carborundum, diamond, or the like). In other embodiments, each of the layers 308 may be stacked and coupled via a binder. In other embodiments, each of the layers 308 may be folded and coupled via the binder. The binder may be glue, fasteners, or the like. In other embodiments, the filter 300 may be constructed using additive manufacturing, or three-dimensional printing. In other embodiments, the filter 300 may be machined with a computer numerical control (CNC) machine, or a similar machine.

The filter 300 can be included with the x-ray system 110. In some aspects, the x-ray system 110 may include multiple filters 300 that the user can insert and remove as desired. In other aspects, the x-ray system 110 may solely include one filter 300 that may or may not be interchangeable with other filters.

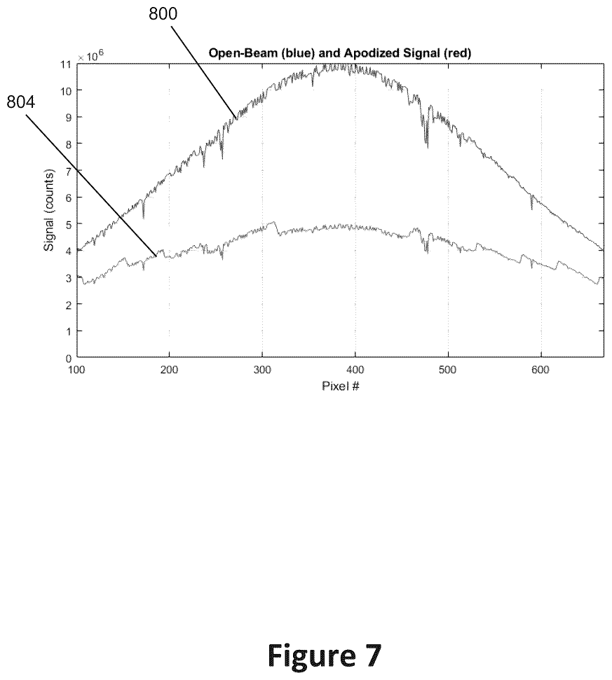

When the x-ray system 110 does not include the filter 300, differences in the path lengths (e.g. 216, 216′) through an embodiment of material 103 having substantially uniform thickness lead to a first x-ray signal level 800 having a curved distribution of signal counts from detector array 113 (e.g. representing an energy distribution), as shown in FIG. 7. This impacts the performance of the x-ray system 110, as explained above. The filter 300 shapes the x-ray energy 114 to produce a more uniform signal profile 804 through the embodiment of material 103 having substantially uniform thickness at detector array 113, as shown in FIG. 7. In other words, the filter 300 helps flatten the curve of the signal profile such that the signal profile is more uniform at detector array 113.

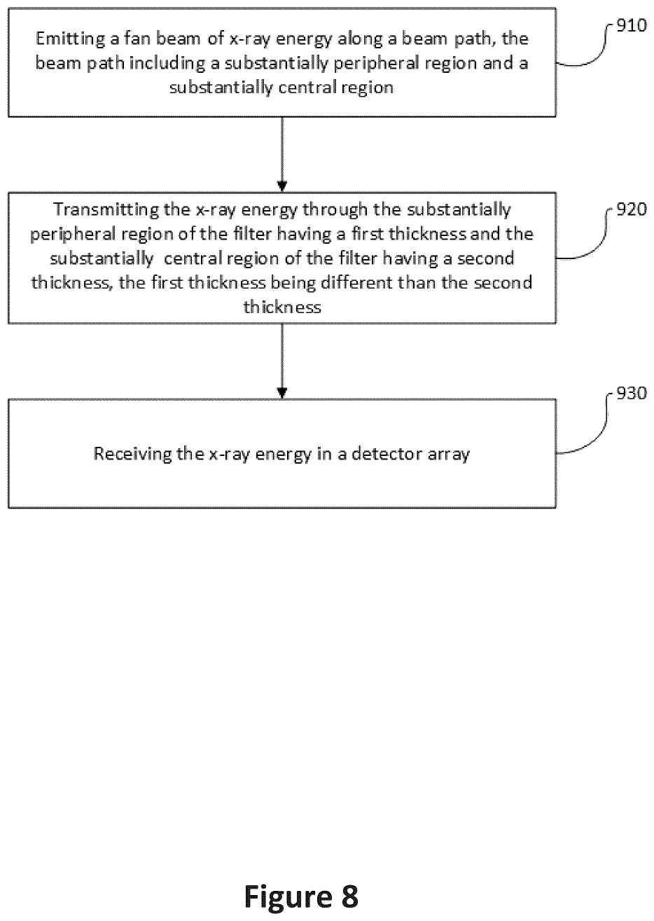

FIG. 8 is a flowchart of an exemplary method for measuring a thickness of a material. At step 910, the method includes emitting a fan beam of x-ray energy along a beam path, where the beam path includes a substantially peripheral region and a substantially central region. At step 920, the method includes transmitting the x-ray energy through the substantially peripheral region of the beam path through a first thickness of a filter and the substantially central region of the beam path through a second thickness of the filter, where the first thickness being different than the second thickness. At step 930, the method includes receiving the x-ray energy in a detector array.

Exemplary implementations of the present disclosure are disclosed in the following clauses:

Clause 1. An x-ray system for measuring a thickness of a material, the x-ray system including:
a source configured to emit a fan beam of x-ray energy along a beam path;
a filter disposed in the beam path, the filter including a first thickness positioned in a substantially peripheral region of the fan beam, and a second thickness positioned in a substantially central region of the fan beam, the first thickness being different than the second thickness; and
a detector array including a plurality of detectors, the detector array configured to detect the x-ray energy transmitted through the filter, wherein the x-ray energy strikes each detector at an angle associated with the region of the fan beam.

Clause 2. The x-ray system of clause 1, wherein the first thickness is less than the second thickness.

Clause 3. The x-ray system of any one of clauses 1 or 2, wherein the filter shapes a spectral energy profile across the substantially central region to the substantially peripheral region of the fan beam.

Clause 4. The x-ray system of any of the preceding clauses, wherein the filter shapes a signal intensity profile of the x-ray energy across the substantially central region to the substantially peripheral region of the fan beam.

Clause 5. The x-ray system of any of the preceding clauses, wherein the filter shapes a material thickness profile of the x-ray energy across the substantially central region to the substantially peripheral region of the fan beam.

Clause 6. The x-ray system of any of the preceding clauses, wherein the fan beam includes a 90-degree fan beam.

Clause 7. The x-ray system of any of the preceding clauses, wherein the filter defines a cross-sectional shape that is concave, convex, asymmetric, stepped, layered, achromatic, or aspheric.

Clause 8. The x-ray system of any of the preceding clauses, wherein the filter includes a plurality of layers.

Clause 9. The x-ray system of any of the preceding clauses, wherein the filter includes a cross-sectional shape having stepped lateral edges.

Clause 10. The x-ray system of any of the preceding clauses, wherein a thickness of the filter is greatest at the substantially center region of the filter.

Clause 11. The x-ray system of any of the preceding clauses, wherein the filter is formed by folding, layering, or 3D printing processes.

Clause 12. The x-ray system of any of the preceding clauses, wherein the filter is formed by a process selected from the group consisting of folding, layering, and 3D printing.

Clause 13. The x-ray system of any of the preceding clauses, wherein the filter includes layers such that some of the layers include a first material and some of the layers include a second material different from the first material.

Clause 14. The x-ray system of any of the preceding clauses, wherein the filter includes a plurality of layers, at least one layer of the plurality of layers includes a first material and at least one other layer of the plurality of layers includes a second material, the second material being different from the first material.

Clause 15. The x-ray system of any of the preceding clauses, wherein the filter includes a plurality of layers, a first layer of the plurality of layers includes a first material and a second layer of the plurality of layers includes a second material different from the first material.

Clause 16. The x-ray system of any of the preceding clauses, wherein the filter includes a first layer including a first material and a second layer including a second material different from the first material.

Clause 17. The x-ray system of any of the preceding clauses, wherein the filter includes a plurality of layers, each layer includes a different material.

Clause 18. The x-ray system of any of the preceding clauses, wherein the filter includes titanium, copper, aluminum, or any combination thereof.

Clause 19. The x-ray system of any of the preceding clauses, wherein the filter includes a ternary cathode material.

Clause 20. The x-ray system of any of the preceding clauses, wherein the filter includes a synthetic material.

Clause 21. An x-ray system for measuring a thickness of a material, the x-ray system includes:
a source configured to emit a fan beam of x-ray energy along a beam path;
a filter disposed in the beam path; and
a detector array including a plurality of detectors, the detector array configured to detect the x-ray energy transmitted through the filter, the x-ray energy striking each detector at an angle associated with the region of the fan beam,
wherein the filter shapes an energy profile of the x-ray energy.

Clause 22. The x-ray system of clause 21, wherein the filter shapes a signal intensity profile of the x-ray energy.

Clause 23. The x-ray system of any one of clauses 21 or 22, wherein the filter shapes a material thickness profile of the x-ray energy.

Clause 24. The x-ray system of any of clause 21 to 23, wherein the fan beam includes a 90-degree fan beam.

Clause 25. The x-ray system of any of clauses 21 to 24, wherein the filter includes layers, at least one of the layers including a first material and at least one of the layers including a second material different from the first material.

Clause 26. The x-ray system of any of clauses 21 to 24, wherein the filter includes a plurality of layers, the plurality of layers includes a first layer including a first material and a second layer including a second material different from the first material.

Clause 27. A method for measuring a thickness of a material, the method includes:
emitting a fan beam of x-ray energy along a beam path, the beam path including a substantially peripheral region and a substantially central region;
transmitting the substantially peripheral region of the beam path through a first thickness of a filter and the substantially central region of the beam path through a second thickness of the filter, the first thickness being different than the second thickness; and
detecting the x-ray energy transmitted through the filter.

Overall, aspects of the disclosure are directed to a filter for compensating for differences in beam lengths of an x-ray source. Such improvements may reside in the structure of the filter, according to embodiments as described herein. Those having skill in the art, with the knowledge gained from the present disclosure, will recognize that various changes can be made to the disclosed devices and methods in attaining these and other advantages, without departing from the scope of the present invention. Accordingly, it should be understood that the features described herein are susceptible to changes or substitutions. The specific embodiments illustrated and described herein are for illustrative purposes only, and not limiting of the invention as set forth in the appended claims.

What is claimed is:

1. An x-ray system for measuring a thickness of a material, the x-ray system comprising:
a source configured to emit a fan beam of x-ray energy along a beam path;
a filter disposed in the beam path, the filter including a first thickness positioned in a substantially peripheral region of the fan beam, and a second thickness positioned in a substantially central region of the fan beam, the first thickness being different than the second thickness; and
a detector array including a plurality of detectors, the detector array configured to detect the x-ray energy transmitted through the filter, wherein the x-ray energy strikes each detector at an angle associated with the region of the fan beam.

2. The x-ray system of claim 1, wherein the first thickness is less than the second thickness.

3. The x-ray system of claim 1, wherein the filter shapes a spectral energy profile across the substantially central region to the substantially peripheral region of the fan beam.

4. The x-ray system of claim 1, wherein the filter shapes a signal intensity profile of the x-ray energy across the substantially central region to the substantially peripheral region of the fan beam.

5. The x-ray system of claim 1, wherein the filter shapes a material thickness profile of the x-ray energy across the substantially central region to the substantially peripheral region of the fan beam.

6. The x-ray system of claim 1, wherein the fan beam comprises a 90-degree fan beam.

7. The x-ray system of claim 1, wherein the filter defines a cross-sectional shape that is concave, convex, asymmetric, stepped, layered, achromatic, or aspheric.

8. The x-ray system of claim 1, wherein the filter includes a plurality of layers.

9. The x-ray system of claim 1, wherein the filter includes a cross-sectional shape having stepped lateral edges, and wherein a thickness of the filter is greatest at the substantially center region of the filter.

10. The x-ray system of claim 1, wherein the filter is formed by folding, layering, or 3D printing processes.

11. The x-ray system of claim 1, wherein the filter includes at least a first layer including a first material and a second layer including a second material different from the first material.

12. The x-ray system of claim 1, wherein the filter includes titanium, copper, aluminum, or any combinations thereof.

13. The x-ray system of claim 1, wherein the filter includes a ternary cathode material.

14. The x-ray system of claim 1, wherein the filter includes a synthetic material.

15. An x-ray system for measuring a thickness of a material, the x-ray system comprising:
a source configured to emit a fan beam of x-ray energy along a beam path;
a filter disposed in the beam path; and
a detector array including a plurality of detectors, the detector array configured to detect the x-ray energy transmitted through the filter, the x-ray energy striking each detector at an angle associated with the region of the fan beam,
wherein the filter shapes an energy profile of the x-ray energy.

16. The x-ray system of claim 15, wherein the filter shapes a signal intensity profile of the x-ray energy.

17. The x-ray system of claim 16, wherein the filter shapes a material thickness profile of the x-ray energy.

18. The x-ray system of claim 16, wherein the fan beam comprises a 90-degree fan beam.

19. The x-ray system of claim 15, wherein the filter includes a plurality of layers, at least one of the layers including a first material and at least one of the layers including a second material different from the first material.

20. A method for measuring a thickness of a material, the method comprising:
emitting a fan beam of x-ray energy along a beam path, the beam path including a substantially peripheral region and a substantially central region;
transmitting the substantially peripheral region of the beam path through a first thickness of a filter and the substantially central region of the beam path through a second thickness of the filter, the first thickness being different than the second thickness; and
detecting the x-ray energy transmitted through the filter.
